(19) United States
(12) Patent Application Publication
(10) Pub. No.: US 2015/0100137 A1
(43) Pub. Date: Apr. 9, 2015

(54) HART CHANNEL INTERFACE COMPONENT INCLUDING REDUNDANCY

(71) Applicant: General Electric Company, Schenectady, NY (US)

(72) Inventors: Daniel Milton Alley, Earlysville, VA (US); Bruce Cameron Henderson, Daleville, VA (US); Longhui Shen, Shanghai (CN)

(21) Appl. No.: 14/571,825

(22) Filed: Dec. 16, 2014

Related U.S. Application Data
(63) Continuation of application No. 13/074,781, filed on Mar. 29, 2011.

(51) Int. Cl. G05B 9/03

(52) U.S. Cl. CPC G05B 9/03
USPC 700/21

(57) ABSTRACT

A channel interface component including redundancy within a control system with highway addressable remote transfer (HART) channels is provided. In one embodiment, a circuit includes: at least two highway addressable remote transfer (HART) channels, each HART channel including an input terminal and an output terminal configured to connect with a HART device via a current loop; an channel interface component coupled to each HART channel that is configured to support HART protocol signals for communications with the HART device, wherein the channel interface component includes a suicide relay switch for connecting or disconnecting each HART channel from the HART device; and a programmable logic device coupled to the channel interface component that is configured to perform modulation and demodulation of HART protocol signals for communications with the HART device.

### PRIORITY CLAIM

This application is a continuation of currently pending U.S. patent application Ser. No. 13/074,781 filed on Mar. 29, 2011. The application identified above is incorporated herein by reference in its entirety for all that it contains in order to provide continuity of disclosure.

### BACKGROUND OF THE INVENTION

The subject matter disclosed herein relates generally to a component within a control system. More particularly, the present disclosure related to a channel interface component including redundancy within a control system with highway addressable remote transfer (HART) channels.

A HART device is generally a sensor or an actuator that may be used, for example, to control or monitor a system, such as a steam turbine or a gas turbine. The HART device facilitates communication within the control system using the well-known HART protocol. A HART sensor device controls current flowing in a wire, while a HART actuator device is controlled by the current flowing in the wire. In accordance with HART protocol, these functions are performed over the current loop carrying a 4 to 20 milliampere (mA) signal that is superimposed with HART data tones.

HART devices are interfaced to the control system along a HART channel using modules that perform current loop measurements and current loop driving. However, if a fault occurs along the HART channel, then communication between the HART device and the control system will be interrupted in order to repair the channel and control of the HART device is delayed.

### BRIEF DESCRIPTION OF THE INVENTION

Aspects of the invention provide for a HART channel interface component including redundancy. In one embodiment, aspects of the invention include a circuit, comprising: at least two highway addressable remote transfer (HART) channels, each HART channel including an input terminal and an output terminal configured to connect with a HART device via a current loop; an channel interface component coupled to each HART channel that is configured to support HART protocol signals for communications with the HART device, wherein the channel interface component includes a suicide relay switch for connecting or disconnecting each HART channel from the HART device; and a programmable logic device coupled to the channel interface component that is configured to perform modulation and demodulation of HART protocol signals for communications with the HART device

A first aspect of the invention provides a circuit, comprising: at least two highway addressable remote transfer (HART) channels, each HART channel including an input terminal and an output terminal configured to connect with a HART device via a current loop; an channel interface component coupled to each HART channel that is configured to support HART protocol signals for communications with the HART device, wherein the channel interface component includes a suicide relay switch for connecting or disconnecting each HART channel from the HART device; and a programmable logic device coupled to the channel interface component that is configured to perform modulation and demodulation of HART protocol signals for communications with the HART device

A second aspect of the invention provides a current loop interface circuit, comprising: at least two highway addressable remote transfer (HART) channel, each HART channel including an input terminal and an output terminal configured to connect with a HART device via a current loop; an channel interface component coupled to each HART channel that is configured to support HART protocol signals for communications with the HART device, wherein the channel interface component includes a suicide relay switch for connecting or disconnecting each HART channel from the HART device; a programmable logic device coupled to the channel interface component that is configured to perform modulation and demodulation of HART protocol signals for communications with the HART device; and an isolation barrier configured to isolate the channel interface component from the programmable logic device.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1 shows a schematic diagram of a system according to embodiments of the invention.

FIG. 2 shows a detailed schematic diagram of a channel interface component according to embodiments of the invention.

FIG. 3 shows a flow diagram of an operational methodology for a system according to embodiments of the invention.

It is noted that the drawings of the invention are not to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

Various embodiments of the present invention are directed to a highway addressable remote transfer (HART) channel interface component that supports HART protocol signals for use in controlling and/monitoring a HART device. In these embodiments, each HART channel interface component includes a suicide relay switch to connect or disconnect the HART channel interface from the HART device. Technical effects associated with the various embodiments of the present invention allow for redundancy of the HART channel interface component and for uninterrupted communication between a control system and the HART device.

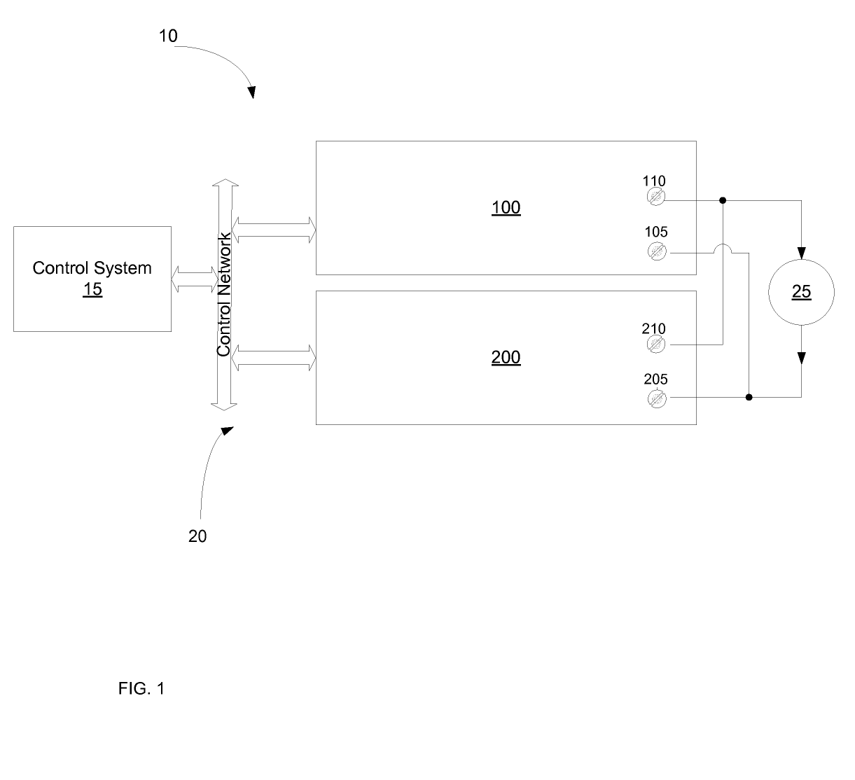

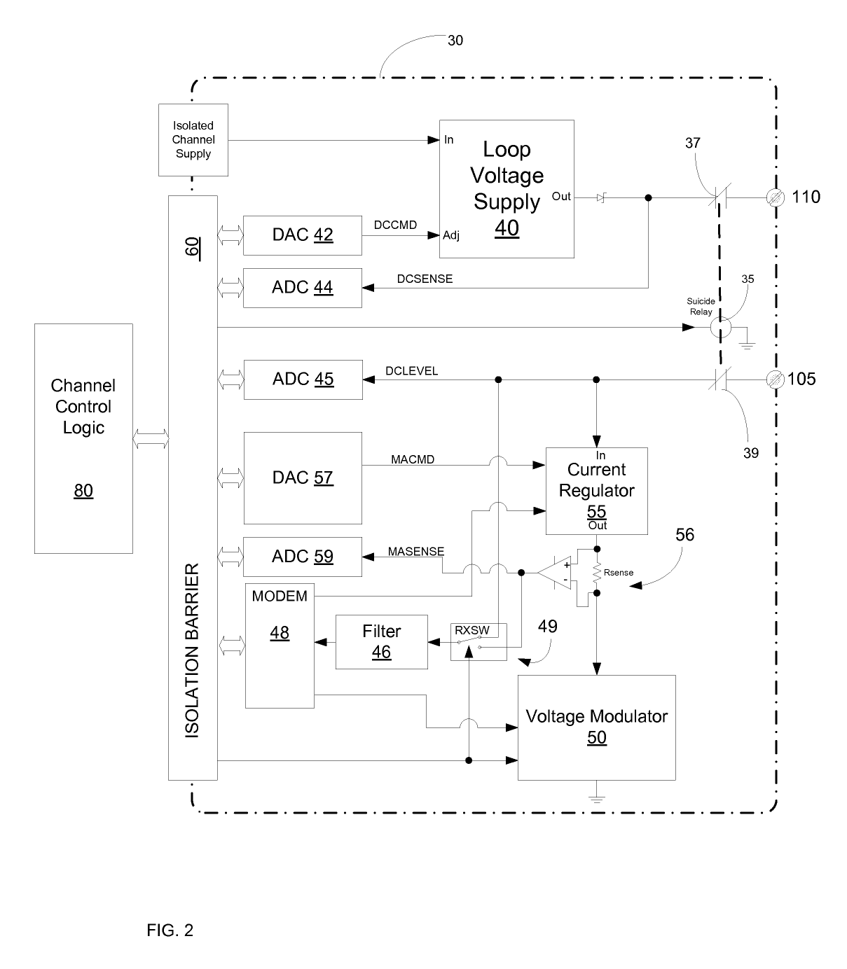

Referring now to the drawings, FIG. 1 shows a schematic diagram of a system 10 including a control system 15 in communication, through a control network 20, with a HART device 25 over a first highway addressable remote transfer (HART) channel 100 or a second HART channel 200. Each channel 100, 200 includes an input terminal 105, 205 and an output terminal 110, 210 configured to connect with HART device 25 via current loop (not shown). As will be shown in FIG. 2, each channel 100, 200 is coupled to a channel interface component 30 that is configured to connect or disconnect first HART channel 100 or second HART channel 200 from HART device 25.

In one embodiment, HART device 25 may be a sensor or an actuator that is used in the control of a turbine. HART device 25 is embedded with the “smarts” to facilitate communication with each channel interface component 30 (FIG. 2) using the well-known HART protocol.

Although system 10 of FIG. 1 is described with respect to use in the control of a turbine, those skilled in the art will recognize that the various embodiments of the present invention are not limited to use solely with monitoring and/or controlling a turbine. The various embodiments of the present invention have a diverse range of applications that are suitable for any environment that includes HART devices.

Further, although system 10 of FIG. 1 is shown to include first HART channel 100 and second HART channel 200, it is understood that system 10 may include any number of channels as necessary for the environment of HART device 25.

Referring now to FIG. 2, a detailed diagram of channel interface component 30 is shown. Further, FIG. 2 shows a programmable channel control logic 80 that is coupled to channel interface component 30 and is configured to perform modulation and demodulation of HART protocol signals for communications with HART device 25 (FIG. 1).

As shown in FIG. 2, channel interface component 30 includes a suicide relay switch 35 that is configured to connect or disconnect the HART channel 100 from HART device 25 (FIG. 1). Although channel interface component 30 is described with respect to HART channel 100, it is understood that HART channel 200 includes the same channel interface component 30.

Suicide relay switch 35 is controlled by programmable channel control logic 80 and, according to the instructions of programmable channel control logic 80, closes or opens contacts 37, 39. If contacts 37, 39 are closed, then HART channel 100 is connected to HART device 25 (i.e., HART channel 100 is considered the “master”). If contacts 37, 39 are open, then HART channel 100 is disconnected from HART device 25 (i.e., HART channel 100 is considered the “slave”). This suicide relay switch 35 provides the redundancy of HART channel 100. If there is a fault along HART channel 100 (i.e., the “master”), programmable channel control logic 80 may send instructions for suicide relay switch 35 to disconnect HART channel 100 from HART device 25. Further, programmable channel control logic 80 may send instructions for suicide relay switch 35 to connect HART channel 200 to HART device 25 (i.e., the new “master’).

Referring back to FIG. 2, channel interface component 30 includes a loop voltage supply 40 that is configured to provide a voltage to HART device 25 (FIG. 1) through terminals 105, 110. Programmable channel control logic 80 may specify a digital current setting that is converted to an analog current setting via a digital-to-analog converter (DAC) 42. The analog current setting (DCCMD) is provided to the loop voltage supply 40 to provide the voltage to HART device 25 (FIG. 1).

In the case that HART device 25 (FIG. 1) includes a sensor, channel interface component 30 may include an analog-to-digital converter (ADC) 44 that digitally represents a measured current from the sensor. The ADC 44 provides the measured current (“DCSENSE”) to programmable channel control logic 80. A voltage modulator 50 is provided for modulating the voltage across terminals 105, 110. In one embodiment, voltage modulator 50 may include a transformer and a transmit driver connected in series (not shown) or may include any other known circuit form.

Channel interface component 30 also includes a current regulator 55. However, in the case of HART device 25 (FIG. 1) including a sensor, the sensor will measure a current for the current loop (not shown). In this case, programmable channel control logic 80 will send instructions (“MACMD”), through DAC 57, to “short” or “saturate” current regulator 55. HART device 25 (FIG. 1), as a sensor, is sent tones by modulating the voltage across terminals 105, 110 by voltage modulator 50. The sensor responds by modulating the measured current via a current resistor 56 and ADC 59. In this way current regulator 55, as set to saturate by programmable channel control logic 80, allows the current to pass through.

In the case that HART device 25 (FIG. 1) is an actuator, a current must be set for the current loop (not shown) in order to control the actuator. Programmable channel control logic 80 will send a digital current setting instructions (“MACMD”), through DAC 57, to current regulator 55 to set a specified DC current for the current loop (not shown). If HART device 25 is an actuator, voltage modulator 50 is set, by programmable channel control logic 80 to a steady state low voltage. Further, ADC 45 is provided to receive a response voltage (“DCLEVEL”) from the actuator.

In either case of a sensor or an actuator for HART device 25 (FIG. 1), channel interface component 30 further includes a switch 49 to select the response signal, which is then passed to a filter 46 to extract HART tones from the measured current and provides the HART tones to a modem 48 and to programmable channel control logic 80. Although modem 48 is shown within channel interface component 30, it is understood that modem 48 may be included within programmable channel control logic 80. Channel interface component 30 also includes an isolation barrier 60 configured to isolate channel interface component 30 from programmable channel control logic 80. Isolation barrier 60 also isolates all other circuitry following through to terminals 105, 110. This allows for galvanic isolation of each channel 30 for electrical safety and isolation.

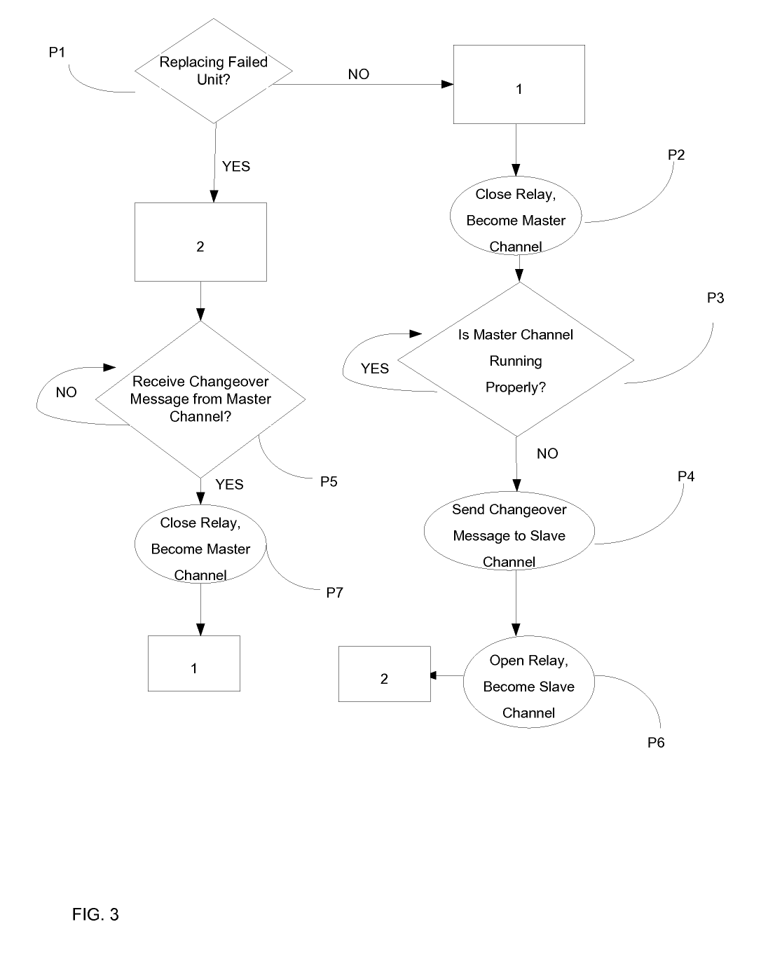

Turning now to FIG. 3, an operational embodiment of system 10 will now be described with references to FIGS. 1 and 2. Although system 10 will be described as including a first HART channel 100 and a second HART channel 200, it is understood that system 10 may include any number of HART channels as the environment requires. Further, it is understood that these operations occur separately within each channel 100, 200, such that channel 100 may be interacting with channel 200. Additionally, channel 100 and channel 200 may be on separate hardware components and each include a separate programmable control logic 80, such that system 10 is interacting with multiple devices.

At process P1, whether a failed unit is being replaced is determined If “no”, for example, with HART channel 100, programmable channel control logic 80 instructs suicide relay switch 35 of channel interface component 30 to close contacts 37, 39 to connect HART channel 100, by terminals 105, 110, to HART device 25. HART channel 100 is now the “master”. If “yes”, for example, with HART channel 200, programmable channel control logic 80 instructs suicide relay switch 35 of channel interface component 30 to leave contacts 37, 39 open so that HART channel 200 is disconnected from HART device 25 and HART channel 100 is now the “slave”.

Following along with the example of HART channel 100 as the “master” channel, at process P3, HART channel 100 is continually checked to determine if HART channel 100 is running properly. If “no”, at process P4, a changeover message is sent to HART channel 200 (i.e., the “slave” channel). At process P5, the changeover message is received by HART channel 200. At process P6 and P7, programmable channel control logic 80 will instruct suicide relay switch 35 of HART channel 100 (i.e., the “master” channel) to open contacts 37, 39 to disconnect HART channel 100 from HART device 25, and also instruct suicide relay switch 35 of HART channel 200 (i.e., the “slave” channel) to close contacts 37, 39 to connect HART channel 200 to HART device 25. In this way, HART channel 200 becomes the “master” channel and HART channel 100 can be replaced and become the “slave” channel.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A circuit for providing redundant highway addressable remote transfer (HART) channels, comprising:
a redundant pair of channel interface components, each having an input terminal and an output terminal configured to connect with a common HART device, wherein each channel interface component includes circuitry for implementing a current loop with the common HART device to operate in a range of approximately four to twenty milliamperes; and
a programmable logic device coupled to a suicide relay switch in each channel interface component for alternatively activating and deactivating the redundant pair of channel interface components by connecting and disconnecting respective current loops to provide a master channel and a slave channel, wherein the programmable logic device is programmable to operate the redundant pair of channel interface components in either a sensing mode or an actuator mode;
wherein each channel interface component includes:
a loop voltage supply for powering the current loop, wherein the loop voltage is controlled by a digital signal from the programmable logic device that is passed through a digital-to-analog converter (DAC);
a voltage modulator and a current regulator arranged in series with a ground, wherein the voltage modulator provides modulated pulses onto the current loop while operating in the sensing mode, and the current regulator provides a current specified from the programmable logic device onto the current loop while operating in the actuator mode; and
an isolation barrier that isolates the channel interface component from both a paired channel interface component and from the programmable logic device.

2. The circuit of claim 1, wherein each channel interface component includes a first switchable contact coupled between the loop voltage supply and an output terminal and a second switchable contact coupled between the input terminal and the current regulator.

3. The circuit of claim 2, wherein the first and the second switchable contacts are controllable in tandem by the suicide relay switch to activate and deactivate the channel interface component.

4. The circuit of claim 3, wherein the suicide relay switch includes at least one of an electromechanical relay and a solid state relay using transistors.

5. The circuit of claim 3, wherein each channel interface component further comprises an analog-to-digital converter (ADC) for converting an analog measured current from the common HART device to a digital value for input into the programmable logic device while operating in sensor mode, wherein the ADC is coupled between the loop voltage supply and first switchable contact.

6. The circuit of claim 1, wherein the current regulator in each channel interface component is controlled by a signal from the programmable logic device via a second DAC, wherein the signal saturates the current regulator while operating in sensor mode and sets a current for the current loop while operating in actuator mode.

7. The circuit of claim 1, further comprising a resistor coupled in series between the voltage modulator and current regulator to capture a sensor response while operating in sensor mode.

8. The circuit of claim 7, further comprising:
a filter for extracting HART tones from the sensor response; and
a modem for processing the HART tones.

9. A circuit for providing redundant highway addressable remote transfer (HART) interfaces for sharing a channel, comprising:
a common HART device on a current loop;
a redundant pair of channel interface components, each having an input terminal and an output terminal configured to connect with the common HART device, wherein each channel interface component includes circuitry for implementing the current loop with the common HART device to operate in a range of approximately four to twenty milliamperes; and
a programmable logic device coupled to a suicide relay switch in each channel interface component for alternatively activating and deactivating the pair of channel interface components by connecting and disconnecting respective current loops to provide a first channel interface component as a master and a second channel interface component as a slave, wherein the programmable logic device is configured to deactivate the first channel interface component and to activate the second channel interface component in response to determining an operational failure of the first channel interface component such that the first channel interface component becomes the slave and the second channel interface component becomes the master, and wherein the programmable logic device is programmable to operate the pair of channel interface components in either a sensing mode and an actuator mode;
wherein each channel interface component includes:
a loop voltage supply for powering the current loop, wherein the loop voltage is controlled by a digital signal from the programmable logic device that is passed through a digital-to-analog converter (DAC);
a voltage modulator and a current regulator arranged in series with a ground, wherein the voltage modulator provides modulated pulses onto the current loop while operating in the sensing mode and the current regulator provides a current specified from the programmable logic device onto the current loop while operating in the actuator mode;
a first switchable contact coupled between the loop voltage supply and an output terminal, and a second switchable contact coupled between the input terminal and the current regulator; and
an isolation barrier that isolates the channel interface component from both a paired channel interface component and from the programmable logic device.

10. The circuit of claim 9, wherein the first and the second switchable contacts are controllable in tandem by the suicide relay switch to activate and deactivate the channel interface component.

11. The circuit of claim 10, wherein each channel interface component further comprises an analog-to-digital converter (ADC) for converting an analog measured current from the common HART device to a digital value for input into the programmable logic device while operating in sensor mode, wherein the ADC is coupled between the loop voltage supply and first switchable contact.

12. The circuit of claim 9, wherein the current regulator in each channel interface component is controlled by a signal from the programmable logic device via a second DAC, wherein the signal saturates the current regulator while operating in sensor mode and sets a current for the current loop while operating in actuator mode.

13. The circuit of claim 9, further comprising a resistor coupled in series between the voltage modulator and current regulator to capture a sensor response while operating in sensor mode.

14. The circuit of claim 13, further comprising:
a filter for extracting HART tones from the sensor response; and
a modem for processing the HART tones.
